(19) United States
(12) Patent Application Publication
(10) Pub. No.: US 2025/0371288 A1
(43) Pub. Date: Dec. 4, 2025

(54) TECHNIQUES FOR IMPLEMENTING MULTIPLE LARGE LANGUAGE MODELS ON A SINGLE PHYSICAL COMPUTING DEVICE

(71) Applicants: Ambarish Ajit Desai, Chantilly, VA (US); Vivek Nair, Malappuram (IN); Rajesh Sanakkayala, Miyapur (IN)

(72) Inventors: Ambarish Ajit Desai, Chantilly, VA (US); Vivek Nair, Malappuram (IN); Rajesh Sanakkayala, Miyapur (IN)

(21) Appl. No.: 19/226,652

(22) Filed: Jun. 3, 2025

Related U.S. Application Data
(60) Provisional application No. 63/655,876, filed on Jun. 4, 2024.

(51) Int. Cl. G06F 40/40; G06F 9/50; G06N 3/045

(52) U.S. Cl. CPC G06F 40/40; G06F 9/5027; G06N 3/045

(57) ABSTRACT

Techniques for executing multiple large language models (LLMs) on a single physical computing device, including receiving a task to be performed by at least a first LLM and a second LLM, creating a plurality of virtual compute nodes on the single physical computing device for processing at least some of first set of sub-tasks to be performed by the first LLM and second set of sub-tasks to be performed by the second LLM, wherein each one of the plurality of virtual compute nodes includes one or more graphics processing unit (GPU) cores allocated for performing a sub-task of the first set of sub-tasks or the second set of sub-tasks, and executing at least some of the first set of sub-tasks and the second set of sub-tasks substantially in parallel across the plurality of virtual compute nodes using shared memory. Inferences between the first and second LLMs may be shared.

### CROSS-REFERENCE TO RELATED APPLICATIONS

This application claims priority under 35 U.S.C. § 119 (e) to U.S. Provisional Application No. 63/655,876, filed on Jun. 4, 2024, entitled “TECHNIQUES FOR IMPLEMENTING MULTIPLE LARGE LANGUAGE MODELS ON A SINGLE PHYSICAL COMPUTING DEVICE”, which is herein incorporated by reference in its entirety.

### BACKGROUND

A Large Language Model (LLM) is an artificial intelligence system designed to understand and generate human-like language on a very large scale, encompassing the architecture, parameters and training methodology used to create it. An LLM is typically built using deep learning techniques (e.g., deep neural networks) and is trained on massive amounts of text data. LLMs are used for natural language processing (NLP) tasks, such as text generation, translation, summarization, question-answers and more. LLMs are characterized by their size, often containing billions of parameters. The scale of these models enables them to capture complex language patterns. LLMs are trained on vast datasets from sources including books, articles, websites, etc.

### SUMMARY

Some embodiments are directed to a method for executing multiple large language models (LLMs) on a single physical computing device, the method comprising: receiving a task to be performed by at least a first LLM and a second LLM; identifying a plurality of sub-tasks associated with the task, the plurality of sub-tasks including a first set of sub-tasks to be performed by the first LLM and a second set of sub-tasks to be performed by the second LLM; creating a plurality of virtual compute nodes on the single physical computing device for processing at least some of the first set of sub-tasks and the second set of sub-tasks, wherein each one of the plurality of virtual compute nodes includes one or more graphics processing unit (GPU) cores allocated for performing a sub-task of the first set of sub-tasks or the second set of sub-tasks; and executing at least some of the first set of sub-tasks associated with the first LLM and the second set of sub-tasks associated with the second LLM substantially in parallel across the plurality of virtual compute nodes.

Some embodiments are directed to a computing device configured to execute multiple large language models (LLMs), the computing device comprising: at least one processor; and at least one non-transitory computer-readable storage medium storing instructions that, when executed by the at least one processor, cause the at least one processor to perform a method comprising: receiving a task to be performed by at least a first LLM and a second LLM; identifying a plurality of sub-tasks associated with the task, the plurality of sub-tasks including a first set of sub-tasks to be performed by the first LLM and a second set of sub-tasks to be performed by the second LLM; creating a plurality of virtual compute nodes on the computing device for processing at least some of the first set of sub-tasks and the second set of sub-tasks, wherein each one of the plurality of virtual compute nodes includes one or more graphics processing unit (GPU) cores allocated for performing a sub-task of the first set of sub-tasks or the second set of sub-tasks; and executing at least some of the first set of sub-tasks associated with the first LLM and the second set of sub-tasks associated with the second LLM in parallel across the plurality of virtual compute nodes.

Some embodiments are directed to at least one non-transitory computer-readable storage medium storing instructions that, when executed by at least one processor, cause the at least one processor to perform a method comprising: receiving a task to be performed by at least a first LLM and a second LLM; identifying a plurality of sub-tasks associated with the task, the plurality of sub-tasks including a first set of sub-tasks to be performed by the first LLM and a second set of sub-tasks to be performed by the second LLM; creating a plurality of virtual compute nodes on a single physical computing device for processing at least some of the first set of sub-tasks and the second set of sub-tasks, wherein each one of the plurality of virtual compute nodes includes one or more graphics processing unit (GPU) cores allocated for performing a sub-task of the first set of sub-tasks or the second set of sub-tasks; and executing at least some of the first set of sub-tasks associated with the first LLM and the second set of sub-tasks associated with the second LLM in parallel across the plurality of virtual compute nodes.

### BRIEF DESCRIPTION OF DRAWINGS

Various aspects and embodiments will be described with reference to the following figures. It should be appreciated that the figures are not necessarily drawn to scale. Items appearing in multiple figures are indicated by the same or a similar reference number in all the figures in which they appear.

FIG. 1 is a diagram illustrating an example single physical computing device on which multiple large language models may be implemented, in accordance with some embodiments of the technology described herein.

FIG. 2 is a diagram illustrating example hardware and software layers implemented on the single computing device of FIG. 1, in accordance with some embodiments of the technology described herein.

FIG. 3 is a flowchart of an illustrative process for executing multiple large language models on a single physical computing device of FIG. 1, in accordance with some embodiments of the technology described herein.

FIG. 4 is a diagram illustrating the steps performed at various hardware and software layers to enable execution of multiple large language models on a single physical computing device of FIG. 1, in accordance with some embodiments of the technology described herein.

FIG. 5 is a diagram illustrating a document summarization task performed using multiple large language models, in accordance with some embodiments of the technology described herein.

FIG. 6 shows a block diagram of software component architecture that enables running multiple LLMs on a single physical computing device, in accordance with some embodiments of the technology described herein.

FIG. 7 is a diagram illustrating interactions between various components of the software component architecture of FIG. 6 to perform a requested inference task, in accordance with some embodiments of the technology described herein.

FIG. 8 shows a block diagram of an exemplary computing device, in accordance with some embodiments of the technology described herein.

### DETAILED DESCRIPTION

With the rise of Artificial Intelligence (AI) and Machine Learning (ML), the development of Generative AI (GenAI) and its variations has been in the works for over a decade. The progress and prominence of GenAI today can be attributed to the substantial computing power employed in training and generating datasets that power solutions like ChatGPT. Suppliers for computing hardware such as Qualcomm, Intel, and Apple have opted for ARM-based Field-Programmable Gate Arrays (FPGAs) and Application-Specific Integrated Circuits (ASICs) for handheld and portable devices. However, the intensive tasks of training and dataset creation have consistently relied on GPUs, especially General-Purpose programmable GPUs (GPGPUs). While GPGPUs excel in rapid computation across various models, their efficiency can be further enhanced by integrating ASICs and FPGAs with their computational capabilities. This integration has given rise to architectures like Nvidia A100 and H100, with similar solutions from AMD, Intel, and Apple with an aim to provide the computing power required for implementing Large Language Models (LLMs).

LLMs, a collaborative outcome of ML and AI, utilize large datasets mapped, tagged, and weighted to execute standard algorithms and derive inferences from natural language prompts or speech. This enables the LLMs to obtain inferences from a set of words (speech or natural language prompts). The LLM then generates the output in a format that the AI/ML platform is engineered to and provides the response in that specific format. This is referred to as Generative AI (GenAI) as it generates a response based on a set of data in natural language. There are several areas where GenAI is making an impact. Developers, architects, and data scientists are building on available platforms and systems to create solutions in a wide variety of domains. The GenAI platforms require LLMs to enable them to generate the inferences and content based on the user prompt(s). These LLMs consume a lot of computing power and GPU resources to perform these computations. Hence, the GenAI solutions are always compute-intensive operations.

The inventors have recognized that current techniques that implement LLMs are unable to execute multiple LLMs on a single physical computing device. Current hardware architectures, such as the Nvidia A100 GPU, use one hundred percent of the available resources on the processor and push the tasks through the hardware interaction layers as well as kernels to the physical hardware. This architecture leads to potential memory and computation leaks as the quantum of tasks is not calculated based on accessible computational cores. To address these drawbacks, the inventors have developed new technology that enables multiple LLMs to be executed in parallel on a single physical computing device by assessing the quantum of tasks and allocating resources accordingly. These techniques improve the performance of, increase efficiency of and dramatically reduce inference time for LLMs.

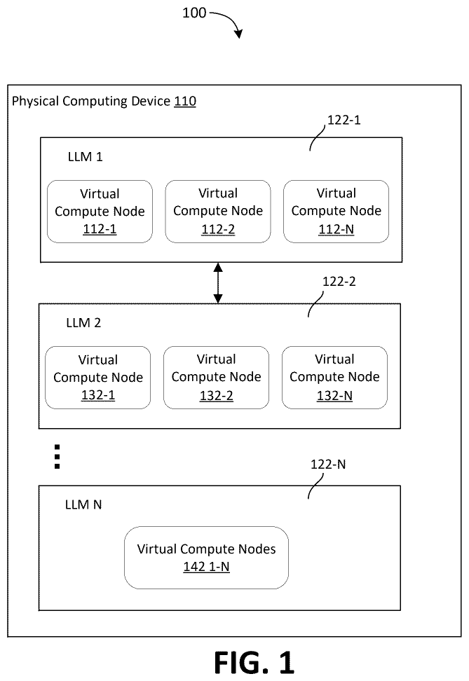

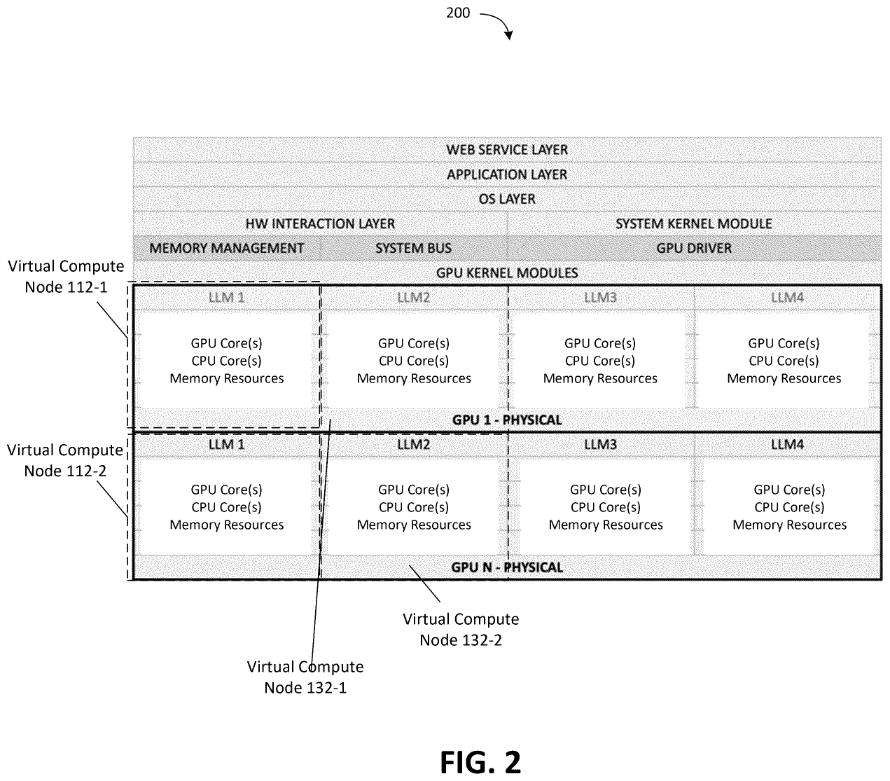

The inventors have recognized that multiple LLMs can be implemented on a single physical computing device by generating customized kernels and drivers intended for parallelizing computational tasks at a tensor core level within General-Purpose Graphical Processing Units (GPGPUs). The technology developed by the inventors includes, for example, a modified GPU driver, a modified GPU kernel, a modified OS kernel and a modified OS driver, which are part of what is referred to herein as a “mSmartCompute” software platform described in more detail below. According to some embodiments, the platform facilitates the execution of multiple LLMs, encompassing both training and inference generation, on a single computing device, whether physical or virtual, by engaging with the hardware in parallel. This capability concurrently enhances the efficiency and effectiveness of AI/ML technologies. For instance, the computation activities that are performed while the GPGPUs are being invoked are mapped and allocated to the available compute cores of the GPGPUs and tasks are split according to the resource availability rather than using the entire device/resources that is available on the compute node. For example, according to some embodiments, the technology creates virtual compute nodes for the task and the load as shown by way of example in FIGS. 1 and 2. These are sequenced and managed using memory allocation techniques, compute node allocation techniques, and/or other dependent modules.

Identifying and configuring a specific hardware setup (e.g., cores, memory, CPU, bus, GPU operations, and/or other modules) can be helpful to achieve optimal performance for running LLMs during training and inference generation. The resources are dynamically allocated on the compute unit based on the demand from each of the LLMs that are residing on the hardware (virtual or physical). This dynamic allocation enhances the speed of LLMs by eliminating the need for network transmissions, ensuring data accessibility within the system bus. For example, leveraging asynchronous barriers in memory sharing and Compute Unified Device Architecture (CUDA) streams in the Nvidia architecture, the technology can employ the available resources, including cores, memory, CPU, bus, CUDA, OpenCV, and other modules, as needed by the application layer modules, such as the LLMs. This enables the LLMs to work faster as there are no computations that need to be transmitted over the network and the data is accessible within the system bus. Leveraging the asynchronous barriers in memory sharing and the CUDA streams, the technology may leverage the available bus pipes of AMD based CPUs on which the customized GPUs are implemented. The AI/ML compute engines can convert the available graphical compute cores into a significantly larger number of virtual compute nodes and effectively utilize all the cores, memory, CPU, bus, CUDA, OpenCV and other modules as and when needed the LLMs.

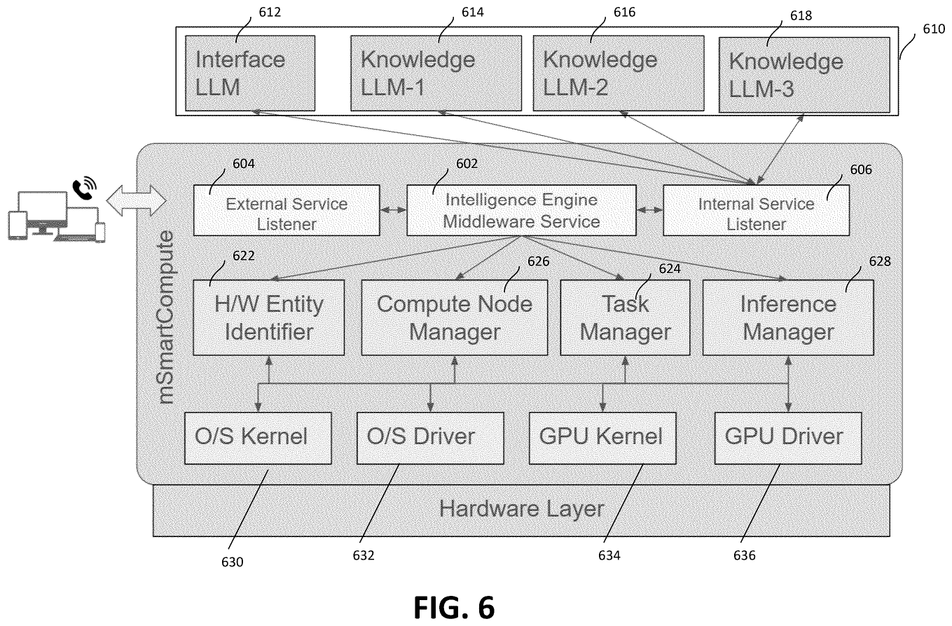

In some embodiments, the new technology developed by the inventors comprises software code that enables running multiple LLMs on a single physical computing device. This software code may be referred to as “mSmartCompute,” which executes in the single physical computing device. It drastically reduces the inference time for LLMs and allows for sharing of inference in real-time between these LLMs. The software code runs multiple LLM tasks in parallel and requires significantly less hardware, compared to traditional alternatives. The software component architecture for mSmartCompute is shown in FIG. 6. As shown in FIG. 6, mSmartCompute comprises an Intelligence Engine Middleware Service 602 (which may be written in Python, C and/or C++) and a Service Listener API that includes two sub-components: External Service Listener 604 and Internal Service Listener 606. The External Service Listener 604 interacts with third-party (e.g., external client(s)) systems or applications initiating a task, for example, to capture user input via prompt submissions or API calls. The Internal Service Listener 606 interacts with the Intelligence Engine Middleware Service (IEMS) 602 and LLMs 610. The IEMS 602 receives requests from the external service listener 604, makes decisions, and directs other components of the mSmartCompute platform. The software developed by the inventors designates an “Interface LLM” 612 that processes the natural language input (received via API calls or from a user input) and determines how to process the request, per instructions from the IEMS 602. The IEMS 602 determines the “Knowledge LLMs” 614, 616, 618 to be used for processing the request task and then breaks down the request task into multiple sub-tasks, sequences them (e.g., as one-to-one or one-to-many Knowledge LLM combinations) and assigns specific sub-tasks to the designated “Knowledge LLMs” 614, 616, 618 available on the same computing device. These knowledge LLMs 614, 616, 618 execute the assigned subtasks in parallel and generate their inferences.

Before a task can be executed, the IEMS 602 calls the “Hardware Entity Identifier” component 622. This component 622 identifies the available cores and memory (for both GPU and CPU) by using the O/S kernel 630, O/S driver 632, GPU kernel 634, and/or GPU driver 636. It also identifies the shared memory spaces which can persist across multiple compute cycles. In some embodiments, the O/S kernel 630 manages system resources, the O/S driver 632 interacts with hardware drivers, the GPU kernel 634 represents custom CUDA kernels performing LLM computations, and the GPU driver 636 manages GPU hardware access.

The “Task Manager” component 624 is called to map the available hardware resources to specific tasks, define a sequence for execution and track the status of the execution pipeline. The “Task Manager” component 624 defines, dispatches, and tracks sub-tasks. The “Compute Node Manager” 626 is invoked by the IEMS 602 to create and configure a number of virtual compute nodes (e.g., one per execution request) for executing these subtasks. A virtual compute node represents a logical allocation of GPU cores and VRAM dedicated to executing an LLM's sub-task. Once execution of a specific subtask related to a Knowledge LLM is complete, the IEMS 602 returns the output to the specific LLM as its interim “inference”. The “Inference Manager” component 628 makes these Knowledge LLMs aware of each other's interim inferences and passes the output to the corresponding LLM, based on the sequence of subtasks assigned to the LLM. The “Inference Manager” component 628 also determines if the combined output needs further processing and instructs the Knowledge LLMs to generate new inferences. This cycle continues until the desired result is achieved and final combined inference is generated. Interface LLM 612 performs further post-processing as required and hands over the output to the IEMS 602, which then translates the output in a desired format. The External Service Listener 604 shares this output to the source of the prompt. The system is designed to optimize the use of underlying hardware components of the computing device.

A single physical computing device may be a tangible piece of hardware that can receive input, process data, and produce output. Examples include personal computers, smartphones, tablets, and microcontrollers like Raspberry Pi. A physical computing device typically consists of several components, such as CPU, memory (e.g., RAM), storage (e.g., hard disk drives (HDDs), solid-state drives (SSDs), or flash memory), input devices (e.g., keyboards, mice, touchscreens, or sensors), output devices (e.g., monitors, speakers, printers, or LEDs), motherboard (i.e., main circuit board that connects and allows communication between all the components of the device), power supply, peripheral connectors (i.e., ports for connecting additional devices, such as USB ports, HDMI ports, audio jacks, etc.), networking components (e.g., Ethernet ports, Wi-Fi adapters, or cellular modems), and cooling system. These components work together to enable the physical computing device to perform its functions.

Although the technology is described in relation to implementation on a single physical computing device, the technology can be implemented on a single virtual computing device without departing from the scope of this disclosure. A single virtual computing device may refer to a software-defined instance of a computer system that runs within a physical computing environment but operates independently. The single virtual computing device may include virtual CPU (e.g., an allocated portion of the physical CPU's processing power), virtual memory (e.g., a portion of the physical memory (RAM) allocated to the virtual machine), virtual storage (e.g., disk space allocated from the physical storage for the virtual machine's use), virtual network interfaces (e.g., virtual network adapters for communication with the external network and other virtual machines), virtual input/output devices (e.g., emulated input/output devices such as virtual keyboards, mice, and display adapters), and virtual BIOS/UEFI (e.g., emulated firmware for booting up the virtual machine. Virtual computing allows multiple virtual machines to run concurrently on the same physical hardware, each operating independently as if it were a separate physical computer.

The current architecture is built to execute LLMs on GPGPUs manufactured by various manufacturers, such as Intel, AMD and Nvidia. The technology works with parallel hardware and does not run a single LLM on a single computing device. Running a single LLM on a single computing device wastes computational power and utilizes the system partially. By contrast, the technology effectively utilizes the available computation and memory capabilities of these GPGPUs to run multiple LLMs on the computing device without wasting computational power.

### General Discussion on LLMs

LLMs typically use “Transformers” (deep neural network architectures) to capture long-range dependencies in sequential data like a language. They are usually pre-trained on a large corpus of text data in an unsupervised manner. During pre-training, an LLM learns to predict the next word in a sentence or fill in missing words, capturing contextual relationships. Fine-tuning is then performed on specific tasks using labeled datasets to adapt the model to specific applications. Examples of known Large Language Models include GPT-3 (Generative Pre-trained Transformer 3), BERT (Bidirectional Encoder Representations from Transformers) and T5 (Text-To-Text Transfer Transformer). LLMs have enabled applications such as chatbots, virtual assistants, content creation, programming code generation and language translation.

An LLM is trained on a specific architecture such as the Transformer architecture for models like GPT-3. Any LLM model is characterized by its parameters, which are learned during the training phase. These parameters define the LLM's ability to understand and generate language. The pre-trained model is loaded into the machine's memory (RAM) or onto a specialized processing unit like a GPU. Input data, typically in the form of text sequences, is tokenized and converted into numerical format suitable for the model. Tokenization involves breaking down the input text into smaller units (tokens) such as words or subwords, each associated with a unique numerical identifier. The input data is fed through the layers of the neural network in a forward pass. Each layer performs computations using the learned parameters, transforming the input data through multiple stages of representation. Activation functions, such as ReLU (Rectified Linear Unit) or GELU (Gaussian Error Linear Unit) introduce non-linearity to the model, enabling it to capture complex patterns in the data. In Transformer models, attention mechanisms allow the model to focus on different parts of the input sequence, capturing dependencies and relationships between words. The final layer's output represents the model's prediction or representation of the input data. The output is often processed further to generate the desired results, whether it's predicting the next word in a sequence, classifying text, or any other language-related task. Depending on the specific task, post-processing steps may be applied to the model's output to obtain the final result, such as converting numerical predictions to human-readable text or making decisions based on the model's output.

The software components of an LLM include elements that contribute to the development, training and deployment of the model. LLMs use Deep Learning Frameworks for building and training the models such as TensorFlow (an open-source deep learning framework developed by Google to provide a set of tools for building and training neural networks) and PyTorch (an open-source deep learning framework developed by Facebook used for dynamic computational graph). Deep learning frameworks typically utilize CUDA (Compute Unified Device Architecture) to offload computations to the GPU. For example, Nvidia GPUs use the CUDA programming model, which allows developers to write parallel programs for execution on Nvidia GPUs. LLMs use several libraries for Natural Language Processing (such as Natural Language Toolkit and spaCy), Transformers Library (such as Hugging Face Transformers that provides pre-trained models for tasks like text classification, translation, and summarization) and libraries for Tokenization and Preprocessing to convert data into a format suitable for training and inference with the model.

The architecture and parameters of the LLM are specified in the form of a configuration file or as part of the model code. Optimization algorithms are used during the training phase (e.g. stochastic gradient descent or advanced optimizers like Adam) to adjust the model's parameters to minimize the loss function. Loss functions quantify the difference between the predicted output and the actual target during training. Different tasks may require different loss functions. Training Scripts (include instructions for loading data, defining the model architecture, and conducting the optimization process) and Inference Scripts (to handle the input data, feed it through the model, and process the output) also form an integral part of the LLM software system. Other components include Evaluation Metrics, Fine-tuning tools, Model Checkpoints (useful for resuming training or deploying a specific version of the model) and Deployment Tools (frameworks for deploying the trained LLM in production environments).

In summary, these software components collectively contribute to the development, training, and deployment of an LLM, allowing it to perform various natural language processing tasks effectively. The choice of specific components depends on the tools used in the development process.

The execution of an LLM involves multiple hardware components working together. The specific components and their roles may vary depending on the model architecture, the size of the model, and the infrastructure used. Example hardware components and their roles are stated below:
Central Processing Unit (CPU): The CPU is responsible for general-purpose computing tasks and managing the overall system. It is involved in coordinating tasks, managing memory, and handling input/output operations.
Memory (RAM): Random Access Memory (RAM) is used to store the model parameters, intermediate computations, and other data required during the execution.
Graphics Processing Unit (GPU): GPUs are well-suited for parallel processing and are beneficial for accelerating the training and inference of LLMs. The GPUs handle the bulk of the computationally intensive tasks involved in deep learning. The model's parameters and data are often loaded into the GPU's memory for faster access during computations.
Tensor Processing Unit (TPU): TPUs (e.g., developed by Google) are specialized hardware accelerators designed specifically for deep learning tasks. TPUs can also handle matrix multiplications and other tensor operations efficiently. They are commonly used in cloud-based machine learning platforms.
Storage (SSD/HDD): Storage devices, such as Solid State Drives (SSD) or Hard Disk Drives (HDD), are used to store the large language model, training data and other related files. During execution, input data may be read from storage, and model checkpoints or logs may be saved.
Custom Hardware (e.g., AI accelerators): Some organizations may deploy custom hardware accelerators designed specifically for deep learning workloads. These can include dedicated AI chips or inference accelerators that are optimized for executing neural network computations.

In summary, while the CPU and memory handle general system management and storage; the GPU, TPU, or other specialized accelerators are used for executing the heavy computational tasks associated with LLMs. The distribution of tasks across these components is orchestrated to optimize the performance of training and inference processes. The choice of hardware depends on factors such as model size, training requirements, and the availability of specialized hardware in the target environment.

Example techniques for execution and parallelization of tasks across multiple LLMs

If a task is determined to be suitable for GPU acceleration, the application or framework responsible for executing the LLM offloads certain parts of the computation to the GPU. This is accomplished by creating a GPU kernel, which is a special function that runs on the GPU. A GPU kernel is the code that performs the actual computation on the GPU and is written in a language compatible with GPU architectures, such as CUDA C or OpenCL. Before a task can be executed on a GPU, the required data is transferred from the system's main memory (RAM) to the GPU's dedicated memory (VRAM) because the GPU operates independently and has its own memory space.

Once a kernel is started, it runs on multiple GPU cores in parallel to process data efficiently. When a GPU kernel completes execution, the results are transferred from GPU memory to the system's main memory. This step allows the CPU and other components to access and use the calculation results. A synchronization mechanism is used to ensure proper coordination between the CPU and GPU. This prevents the CPU from continuing with subsequent tasks until the GPU has completed its calculations and the results are available for further processing. Device drivers facilitate communication between the operating system, CPU, and GPU. GPU drivers handle the low-level details of data transfer, kernel execution, and synchronization, abstracting the complexity from application developers. Frameworks like TensorFlow, PyTorch, etc. abstract the complexities of GPU programming and provide high-level APIs that enable efficient parallelization of tasks on the GPU. GPU processing involves running tasks on a graphics processing unit (GPU), which is special hardware designed for parallel processing.

In some embodiments, parallelization of the activities of each LLM is identified by leveraging DMA (dynamic memory allocation) and GPU-dedicated VRAM on CPU cores and system memory to facilitate large-scale execution. GPUs are designed with a parallel architecture that includes thousands of small processing units called CUDA cores (for NVIDIA GPUs) or stream processors (for AMD GPUs). These cores are organized into streaming multiprocessors (SMs) or computing units. GPUs follow a SIMD model in which a single instruction is executed simultaneously by multiple cores on different data elements. This allows GPUs to perform the same operations on large amounts of data in parallel. The parallelization features described above allow virtual allocation of a set of GPU computing cores (CUDA or streams) or processing units to each LLM as a “virtual compute node”. The DMA feature allows allocation of VRAM and system RAM to these virtual compute nodes. Efficient memory management techniques enable data to be transferred between CPU and GPU memory as needed.

The kernel code is modified to run as a separate set of compute nodes for the group of LLMs in the new architecture. The kernel runs on the GPU, and each instance of the kernel is responsible for processing small units of data in parallel. The kernel runs in parallel by organizing threads into groups called blocks. Each block contains multiple threads, and these blocks are scheduled to run on available SMs or compute units. Threads within a block can communicate and synchronize using shared memory. The smallest unit of execution on a GPU is a warp (NVIDIA) or wavefront (AMD), which is a group of threads that execute in lockstep. This ensures efficient SIMD execution as all threads within a warp or wavefront execute the same instructions simultaneously. Global memory is accessible by all threads and is used for communication between different blocks. Shared memory, on the other hand, is shared between threads within a block, allowing faster access. Efficient use of memory is beneficial to optimizing GPU performance. The GPU scheduler manages the distribution of tasks among the available processing units. It determines which blocks and threads to run at any given time, considering factors such as resource availability and dependencies between tasks. To maximize memory bandwidth, GPU memory accesses are configured to minimize data transfer time. This is achieved through techniques such as merged memory access, where adjacent threads access contiguous memory locations. Inside a block, threads can use barriers to synchronize their execution. This ensures that all threads have completed their specific tasks before continuing, facilitating coordinated parallelism. For NVIDIA GPUs, the CUDA runtime and API provide a high-level interface that allows writing GPU-accelerated applications. These include memory management, kernel execution, and synchronization functions. Direct programming at the GPU level enables fine-grained control to parallelize and accelerate processing of tasks in an efficient manner.

The following table (Table 1) outlines step by step execution of LLM tasks in a conventional system and compares it with how the newly technology developed by the inventors would execute the same corresponding step.

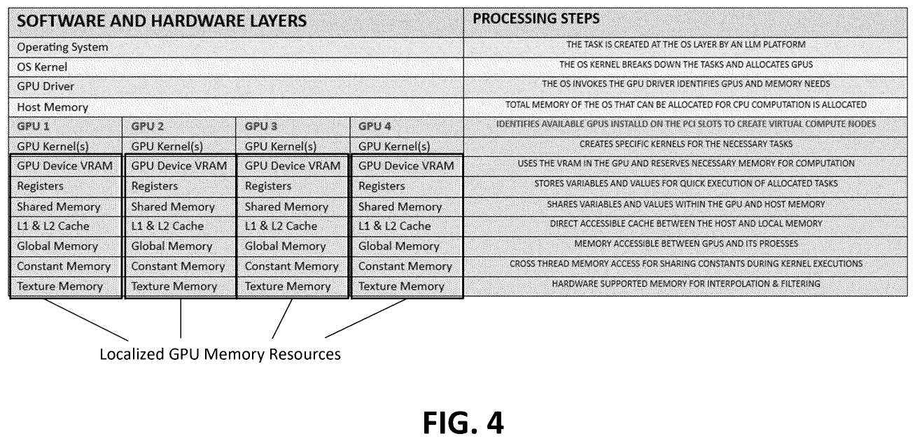

TABLE 1

| | | Modifications implemented by the newly |
|---|---|---|
| Step | Step to execute LLM Tasks in | developed architecture/technology for the |
| No. | conventional systems | corresponding step |
| 1. | Data Preparation: The data to be | Data is still stored in the RAM and remains |
| | processed is typically stored in the | there until it is prepared and directly assigned |
| | system's main memory (RAM). In GPU | to the virtual compute nodes. The |
| | programming, data is prepared on the | intermediate allocation logic and data |
| | CPU side before being transferred to the | structures are mapped onto the GPU and its |
| | GPU. This may involve creating data | various memory modules, wherein there is no |
| | structures, allocating memory, and | data transfer occurring between memory |
| | initializing values. | locations. The Hardware Entity Manager 622 |
| | | and/or Compute Node Manager 626 may |
| | | perform this step. |
| 2. | Memory Allocation on GPU: Memory | The memory allocation functions are defined |
| | space is allocated on the GPU to store the | within the GPU driver itself to identify which |
| | data. This is done using GPU-specific | GPU is being used, along with the |
| | memory allocation functions. For | corresponding functions, which are named as |
| | example, CUDA provides functions like | follows: |
| | ‘cudaMalloc’ to allocate memory on the | allocMemCuda - Invokes |
| | GPU. | cudaMaclloc |
| | | allocMemAMD - Invokes |
| | | openglMalloc-amd |
| | | allocMemIntel - Invokes |
| | | openglMalloc-Intel |
| | | allocMemASIC - Invokes |
| | | openglMalloc-asic |
| | | allocMemFPGA - Invokes |
| | | openglMalloc-fpga |
| | | In some embodiments, the Task Manager 624 |
| | | and/or Compute Node Manager 626 may |
| | | perform this step. |
| 3. | Data Transfer to GPU: Once memory | The GPU driver creates a new set of CPU, |
| | is allocated on the GPU, the data is | GPU and corresponding memory units as one |
| | copied from the CPU main memory to | single “virtual compute node” for one |
| | the GPU memory. CUDA provides | allocation set. This can be done over multiple |
| | functions like ‘cudaMemcpy’ to transfer | devices (GPUs) and using partial CPU |
| | data between the CPU and GPU. There | cores. The system identifies persistent |
| | are options to transfer data in both | memory locations to be reused for computing, |
| | directions: from the CPU to the GPU | so that the data duplication is prevented. The |
| | (host to device) and from the GPU to the | In some embodiments, Compute Node |
| | CPU (device to host). | Manager 626 may create these virtual |
| | | compute nodes. |
| 4. | Kernel Launch: The CPU initiates the | The allocation of the threads and blocks to |
| | execution of the kernel by launching it | corresponding virtual compute nodes happens |
| | with a specified number of threads and | through the CPU and GPU drivers. However, |
| | blocks. CUDA kernels are launched | since virtual compute nodes from the CPU |
| | using programming code syntax like | level to the GPU and its memory units are |
| | ‘kernelFunction<<<numBlocks, | used, there are multiple instances that would |
| | numThreads>>>(arguments) | run over the virtualized modules in |
| | | parallel. The GPU driver is modified to |
| | | manage these virtual kernels and its related |
| | | triggers. Once a virtual compute node |
| | | executes, the corresponding virtual kernel |
| | | gets launched. In some embodiments, this |
| | | step may be performed by Task Manager 624 |
| | | and/or Compute Node Manager 626. |
| 5. | Parallel Execution on GPU: The GPU | The modified GPU driver enables multiple |
| | executes the kernel in parallel across | virtual kernels to be created for each set of |
| | multiple threads and blocks. Each thread | execution tasks. Therefore, the parallel |
| | within a block runs the same kernel code | executions are also performed in a multi- |
| | but with different data or indices. | threaded fashion for each invocation of the |
| | | virtual kernel. This enables the system to |
| | | execute multiple virtual kernel invocations, |
| | | followed by multiple blocks in parallel, as |
| | | well as various threads associated within each |
| | | virtual compute node. Due to the granularity |
| | | of computation tasks, the resource utilization |
| | | of physical tensor cores is significantly more |
| | | efficient because the parallelized virtual |
| | | computation reuses the physical cores across |
| | | multiple compute cycles. The system |
| | | developed by the inventors is able to achieve |
| | | this by breaking down the threads into tasks |
| | | that can be executed in smaller compute |
| | | cycles and the virtual kernel can release the |
| | | physical tensor core for the next virtual |
| | | compute node. In some embodiments, this |
| | | step may be performed by the Task Manager |
| | | 624. |
| 6. | Data Access and Computation: | The allocation of VRAMs and its related |
| | Threads in the GPU access data from the | computations are also defined in the GPU |
| | GPU's memory (VRAM) and perform | driver programming code. It uses the new |
| | parallel computations as defined by the | approach of virtual compute nodes, as stated |
| | kernel. Compute cores in the GPU | earlier and illustrated in FIGs. 2 and 4. Data |
| | handle the parallel processing of data. | Access and Computation is more effective in |
| | | the system developed by the inventors as |
| | | persistent memory is shared across virtual |
| | | compute nodes, thereby reducing memory |
| | | reads/writes. In some embodiments, the |
| | | IEMS 602 may invoke the Compute Node |
| | | Manager 626 and/or Task Manager 624 to |
| | | perform this step. |
| 7. | Memory Hierarchy: The GPU has a | Memory hierarchy is maintained as illustrated |
| | memory hierarchy that includes registers, | in FIG. 4. The system developed by the |
| | shared memory and global memory. | inventors maintains persistent shared memory |
| | Threads within a block can efficiently | in both GPU and CPU-accessible memory |
| | share data using shared memory, while | locations. The persistence of data in CPU and |
| | global memory is accessible to all | GPU context reduces the need for memory |
| | threads but has higher latency. | address copy and/or deletion during the |
| | | virtual compute cycles. This improves the |
| | | efficiency of memory hierarchy management. |
| | | In some embodiments, this step may be |
| | | performed by the Task Manager 624. |
| 8. | Result Gathering: Once the parallel | Based on the thread and the block, the virtual |
| | computation is complete, the results are | kernel is directed by the GPU driver to copy |
| | stored in the GPU's memory. If the | the results to the global memory that is |
| | results need to be accessed by the CPU, | mapped to the virtual compute node and its |
| | they must be transferred back to the | associated memory for further processing. In |
| | CPU's main memory. | some embodiments, this step may be |
| | | performed by the IEMS 602, Compute Node |
| | | Manager 626, Task Manager 624 and/or |
| | | Inference Manager 628. |
| 9. | Data Transfer from GPU: CUDA | Using the same concepts for memory |
| | provides functions like ‘cudaMemcpy’ to | allocation, the data is referenced from the |
| | transfer data from the GPU to the CPU. | virtual compute node to the shared memory |
| | This step is beneficial when the results | address accessible by the CPU. As a result, |
| | computed on the GPU need to be used or | the need for data transfer between GPU and |
| | analyzed on the CPU. | CPU is drastically reduced. In some |
| | | embodiments, the IEMS may instruct the |
| | | Task Manager 624 to perform this step. |
| 10. | Memory Deallocation: After the | Using the similar logic in memory allocation, |
| | computation is complete, the allocated | the GPU driver uses the corresponding |
| | GPU memory may be freed up to avoid | module associated with the available |
| | memory leaks. CUDA provides functions | hardware to deallocate the memory after use. |
| | like ‘cud aFree’ for deallocating GPU | In some embodiments, the IEMS may invoke |
| | memory. | the Hardware Entity Identifier 622, which |
| | | then keeps track of the available memory that |
| | | can be deallocated. |

In some embodiments, the following steps may be taken to identify how may virtualization layers are needed to compute a specific task.
1. Instruction set identification.
2. Instruction size calculation.
3. Instruction queue length calculation.
4. Physical compute cores that are unused.
5. Identification of free compute cores per physical device.
6. Identification of memory that is free in each physical device.
7. Computation to create virtual compute nodes and GPC layers at each physical device.

In some embodiments, the technology developed by the inventors, for example, a single physical computing device with 2 GPUs and the mSmartCompute software, can provide more than 60% better performance over conventional techniques when running two or more large language models in parallel.

FIG. 4 is a diagram illustrating the steps performed at various hardware and software layers to enable execution of multiple large language models on a single physical computing device of FIG. 1, in accordance with some embodiments of the technology described herein. FIG. 4 defines the steps performed by the mSmartCompute platform and shows the processing/computation performed at and the flow of control and information between the various software and hardware layers of the single computing device for each task request.

Example implementation using Nvidia hardware architecture

The technology is designed to operate in a Linux environment, for example, Debian-based Ubuntu. The inventors have developed a software layer to directly enable interaction of the LLM engines with the compute nodes. The approach uses the C++ middleware to create memory spaces and computation task identification at a compute node level, create the set of requests that are in queue and assigned weightage by the LLM, and thereby allocate necessary resources from the compute nodes to process the queues with highest weightages in a first-in-first-out (FIFO) sequence. Traditional AI engines or deep learning frameworks (e.g., TensorFlow, Pytorch) are replaced by LLM entries because interaction between the application layer and the hardware layer is made possible by modifying the kernel and driver of the GPGPU. Memory partitioning is implemented in the A/H 100 GPGPUs in C++, and the opensource code was modified to allow dynamic memory allocation (DMA) from/within the application layer. Using python modules to read and access C++ pointers, resources that are being used and that are unused can be identified. Based on the load, the technology creates virtual compute nodes and frees them up as soon as the computational workload is finished. Each of these delegative tasks are effectively managed using AMD CPUs that have maximum virtual cores and DMA channels. Therefore, a combination of the CPU, GPU and memory enables creation of virtual compute nodes that can be used to implement multiple LLMs in parallel. The architectural advantages of compute driven GPU design enable customization of the specific address spaces and locations within a single GPU device and creation of compute nodes across multiple hardware components, thereby creating a virtually dedicated computation node for each of the LLMs. The architecture of Nvidia also provides leverage in implementing these customizations, e.g., the NVLink Network interconnect enables GPU-to-GPU communication among up to 256 GPUs across multiple compute nodes. Secure MIG (Multi-Instance GPU) partitions the GPU into isolated, right-size instances to maximize quality of service (QOS) for smaller workloads. NVIDIA's H100 GPU extends A100's global-to-shared asynchronous transfers across all address spaces and adds support for tensor memory access patterns. It enables applications to build end-to-end asynchronous pipelines that move data into and off the chip, completely overlapping and hiding data movement with computation. Orchestrating the growing number of on-chip accelerators and diverse groups of general-purpose threads requires synchronization. For example, threads and accelerators that consume outputs typically wait on threads and accelerators that produce them. These hardware systems are capable of up to 500 teraflops of computations. For every single area that Nvidia A/H 100 GPGPUs are best suited due to the dynamic partitioning capabilities, the newly developed technology can run multiple large language models in each of those domains and effectively provide improved performance and effectiveness.

In the context of effectiveness and efficiency, when the LLMs are accessing the same shared memory for inferences and prompts, the turnaround time related to the information being passed amongst the systems is negligible. There is minimal or no latency when it comes to communication between the LLMs. The effectiveness of the GPGPUs, its dedicated memory, system/host memory and other storage media are all happening within the host system. This enables the platform to be more effective compared to any networked or hosted GenAI systems or LLMs. This configuration can be attained by modifying the kernel of the host operating system and the drivers of the GPGPU. In some embodiments, standard include files used during kernel and operating system compilation are modified to ensure that this alteration of the process flow and data management are applicable to any manufacturer. There are manufacturer specific changes that are performed as well to enhance these modifications to these devices.

Through the implementation of optimized and custom-designed algorithms, the technology maximizes the utilization of dormant compute cores, surpassing the capabilities of the open-source driver. This breakthrough allows for an unprecedented ability to run large language models in parallel on a single hardware unit.

Although implementation details have been described for Nvidia architecture, the technology can be implemented on other GPGPUs, for example, AMD GPGPUs featuring tensor cores, without departing from the scope of this disclosure.

### Example Use Case: Document Summarization Using Multiple LLMs

List of LLMs used:
Interface LLM-Chat based variant of GPT 3 trained on natural language prompts.
Knowledge LLM 1-Technical document model and dataset downloaded as pre-trained with REST JSON API prompting.
Knowledge LLM 2-Pre-trained text summarization model with REST JSON API prompting.
Knowledge LLM 3-Thesaurus LLM Model-GPT3 REST JSON API prompting.
Knowledge LLM 4-English Oxford dictionary and grammar reference books—6 TB dataset with GPT 3 REST JSON API prompting.

Hardware used—4 Nvidia H100 GPUs with 32 GB RAM each connected using NVLink, on an AMD Thread ripper 128 Core CPU and 512 GB RAM, with 10 TB storage.

Software used—The system is designed to operate in a Linux environment, specifically Debian-based Ubuntu and has the customized kernel for Nvidia H100 GPU as well as patches for the driver installed, as part of mSmartCompute software.

The Step-by-Step execution details for the “Document Summarization” Use Case is explained below in Table 2. The Interface LLM receives a prompt to “summarize the attached PDF document into a 2-page summary”. The following Table 2 shows how the system generates a response using 4 Knowledge LLMs and mSmartCompute software. All LLMs and mSmartCompute are installed on a single physical computing device.

TABLE 2

| # | Process Step | Summary | Execution Details | mSmartCompute Software Code used |
|---|---|---|---|---|
| 1. | Prompt received | External Service | System creates a hash of the | msc_intelligence_core.py |
| | by the system to | Listener receives the | file and stores the content of | |
| | summarize the | request and passes it | the file at a dedicated | |
| | attached document | to the Intelligence | location in the form of a | |
| | | Engine. | vector database. The | |
| | | | External Service | |
| | | | Listener receives the request | |
| | | | and sends it to the | |
| | | | Intelligence Engine. The | |
| | | | Intelligence Engine identifies | |
| | | | the hash and creates the | |
| | | | embeddings to the Interface | |
| | | | LLM. | |
| | | | Embeddings are a type of | |
| | | | numerical representation that | |
| | | | captures the semantic | |
| | | | meaning of words, phrases, | |
| | | | sentences, or even entire | |
| | | | documents. These are dense, | |
| | | | fixed-length vectors that | |
| | | | represent textual data in a | |
| | | | continuous vector space. | |
| | | | They are designed to capture | |
| | | | the meaning and contextual | |
| | | | relationships between words | |
| | | | or other textual units. | |
| | | | Embeddings can be used to | |
| | | | convert categorical data (like | |
| | | | words) into numerical form, | |
| | | | which can be processed by | |
| | | | machine learning models. In | |
| | | | LLMs, embeddings can be | |
| | | | used in various stages: | |
| | | | 1. Input Representation: Text | |
| | | | is converted into embeddings | |
| | | | before being fed into the | |
| | | | model. This allows the | |
| | | | model to process the text | |
| | | | numerically. | |
| | | | 2. Model Training: During | |
| | | | training, embeddings are | |
| | | | fine-tuned to better capture | |
| | | | the nuances and semantics of | |
| | | | the training data, improving | |
| | | | the model's ability to | |
| | | | understand and generate text. | |
| | | | 3. Transfer Learning: Pre- | |
| | | | trained embeddings (e.g., | |
| | | | those learned by BERT) can | |
| | | | be transferred to other tasks, | |
| | | | providing a starting point | |
| | | | and reducing the amount of | |
| | | | data and computation | |
| | | | required for training on new | |
| | | | tasks. | |
| 2. | System initializes | Interface LLM | Context may include | msc_intelligence_core.py, msc_di.py, |
| | the Request | extracts context of | information (e.g., generic | msc_dta.py and msc_rigved_mw.py |
| | Pipeline to LLMs | embeddings and | keywords in the document to | |
| | | provides it as input to | identify domain, page-to- | |
| | | the Intelligence | page relationships, etc.) | |
| | | Engine (via the | extracted from documents | |
| | | Internal Service | included in the prompt. | |
| | | Listener). Intelligence | There are intelligent and | |
| | | Engine then | enumeration ML models to | |
| | | determines which | identify specific LLMs to be | |
| | | LLMs to use to | used. | |
| | | process the request. | | |
| 3. | mSmartCompute | Intelligence Engine | Hardware Entity Identifier | Modified version of Nvidia kernel code |
| | identifies available | invokes the Hardware | uses the system kernel to | module nv_gpu_ops.h. |
| | hardware entities | Entity Identifier | identify the available cores | |
| | | component. | of the GPU, its available | |
| | | | RAM, host machine CPU, | |
| | | | system RAM and the number | |
| | | | of compute cores (physical) | |
| | | | in the system. The | |
| | | | identification process also | |
| | | | calculates the free cores and | |
| | | | memory for both GPU & | |
| | | | CPU. | |
| 4. | Capacity planning, | Intelligence Engine | Intelligence Engine | Modified Nvidia kernel code modules nv- |
| | task assignment, | assigns the | determines how to process | kthread-q-os.h, nv-hypervisor.h, |
| | creation of virtual | appropriate tasks to | the document vector. It | nv_memory_type.h, i2c_nvswitch.c, nv.c |
| | compute nodes and | each LLM and then | invokes LLM1 and | mem_data_alloc.c, mem_alloc.c, |
| | allocation of | calls the Compute | LLM2. It calls the Compute | reg_mem.c, ctx_alloc.c, cpu_alloc.c, |
| | resources. | Node Manager and | Node Manager for allocation | host_device_mem.c, no_device_mem.c, |
| | | Task Manager to | and computation planning to | pool_alloc.py, virtual_mem.c |
| | | execute these tasks. | schedule the execution of the | |
| | | K-LLM1 is assigned | tasks on the available | |
| | | to create a page-wise | resources identified in the | |
| | | dataset. K-LLM2 is | above step. This process | |
| | | assigned to generate a | results in creation of virtual | |
| | | summary. K-LLM3 is | compute nodes and the count | |
| | | assigned to check for | of tasks to be performed on | |
| | | alternative words. K- | them. The duration these | |
| | | LLM4 is assigned to | resources to be allocated (for | |
| | | correct or update the | creation, usage & removal) | |
| | | summary. | is also calculated. | |
| 5. | K-LLM1, K- | Intelligence engine | KLLM-1 starts creating the | msc_tvd_lookup.py, msc_promptgen.py, |
| | LLM2, K-LLM3 | calls the knowledge | page-wise dataset. It finishes | msc_alloc_hw.py, msc_gen_data.py, |
| | and K-LLM4 | LLMs to execute and | the interim inference | msc_strat.py, msc_strat_iden.py, |
| | begin execution | invokes the Task | generation for page 1. K- | msc_smartserv.py, msc_gentensorneed.py, |
| | sequence | Manager and | LLM2 takes the first dataset | msc_genmemneed.py |
| | | Inference Manager to | and creates the summary as | |
| | | sequence and track | its interim inference. | |
| | | the execution activity. | Intelligence Engine sends | |
| | | | that summary to K-LLM3 to | |
| | | | check for alternative words | |
| | | | and compress. It then calls | |
| | | | K-LLM4 to check this | |
| | | | inference and enhance or | |
| | | | update the output. This | |
| | | | completes cycle 1. | |
| 6. | All LLMs execute | While K-LLM2 starts | These LLM tasks execute in | console_mem.c, ctx_buf_pool.c, |
| | in parallel | generating the | parallel on the available | egm_mem.c, fabric_vaspace.c, fla_mem.c, |
| | | summary for the page | virtual compute nodes. Task | gpu_vaspace.c, hw_resources.c, |
| | | 1 dataset, K-LLM1 | Manager tracks the resource | io_vaspace.c, mem.c, mem_export.c, |
| | | continues its work for | usage and execution status, | mem_fabric.c, mem_fabric_import_ref.c, |
| | | generating the output | as these LLMs process the | mem_fabric_import_v2.c, mem_list.c, |
| | | (page 2, then page 3 | entire dataset, page by page | mem_mgr_internal.c, |
| | | and so on). Similarly, | by iterating through the | hmem_multicast_fabric.c, |
| | | K-LLM2 starts on | cycles. Inference Manager | no_device_mem.c, os_desc_mem.c, |
| | | page 2 summary, | decides when the cycle of | phys_mem.c, pool_alloc.c, reg_mem.c, |
| | | while K-LLM3 and | inference generation is | standard_mem.c, system_mem.c, |
| | | K-LLM4 are working | complete. As each cycle | vaddr_list.c, vaspace.c, video_mem.c, |
| | | on enhancing and | executes, the system | virt_mem_mgr.c, virt_mem_range.c, |
| | | compressing the | compiles the dataset and | virtual_mem.c |
| | | summary for page 1. | passes it to the intelligence | |
| | | Each LLM continues | engine by mapping the data | |
| | | task execution in | sets from all the memory | |
| | | parallel. | units to a persistent storage | |
| | | | memory unit which can be | |
| | | | accessed by the interface | |
| | | | LLM. | |
| 7. | Final Document | Once all pages are | Once the system completes | mem_data_alloc.c, mem_alloc.c, |
| | Summary is | processed and the | the inference generation | reg_mem.c, ctx_alloc.c, cpu_alloc.c, |
| | generated | combined inference | cycle for the first set of | host_device_mem.c, no_device_mem.c, |
| | | summary is generated, | inferences, the next set of | pool_alloc.py, virtual_mem.c, nv_rnn.c, |
| | | the Inference Manager | inferences is generated again | msc_bert.c |
| | | repeats steps 5 and 6 | for reinforced learning. This | |
| | | until the desired | step uses reinforced learning | |
| | | outcome is achieved. | neural networks and | |
| | | | Bidirectional Encoder | |
| | | | Representations from | |
| | | | Transformers (BERT). At | |
| | | | the end of each cycle, the | |
| | | | Inference Manager shares | |
| | | | the output with the Interface | |
| | | | LLM. The inference | |
| | | | generation cycle continues | |
| | | | until the Interface LLM is | |
| | | | satisfied with the summary | |
| | | | (i.e. until all conditions for | |
| | | | successful inference are | |
| | | | met). | |
| 8. | Output PDF | K-LLM1 takes the | K-LLM1 sends the summary | msc_intelligence_core.py, msc_di.py, |
| | document is | final summary dataset | dataset to the Intelligence | msc_dta.py and msc_rigved_mw.py |
| | created and a | and sends it to the | Engine to create a PDF | |
| | download URL is | Intelligence Engine to | format, which then instructs | |
| | sent to the | generate a PDF | the External Service Listener | |
| | requestor | document. External | to generate a download URL | |
| | | Service Listener | for the requestor. In this step, | |
| | | creates a download | the contextual data passed to | |
| | | URL for this | the Intelligence Engine is | |
| | | document and shares | merged and enhanced by the | |
| | | it with the requestor. | Interface LLM. | |

FIG. 1 is a diagram 100 illustrating an example single physical computing device 110 on which multiple LLMs may be implemented, in accordance with some embodiments of the technology described herein. As shown in FIG. 1, LLMs 122-1, 122-2, . . . , 122-N may be implemented on the physical computing device 110.

In some embodiments, a plurality of virtual compute nodes may be created on the physical computing device 110 for processing a task. For example, a task may include a document summarization task, where the document summarization task includes a first set of sub-tasks (e.g., generating a summary) to be performed by a first LLM, such as, LLM 122-1 and a second set of sub-tasks (e.g., correcting or updating the generated summary) to be performed by a second LLM, such as LLM 122-2.

In some embodiments, a number of virtual compute nodes 112-1, 112-2, . . . 112-N; 132-1, 132-2, . . . 132-N; 142-1, . . . 142-N; may be created for processing at least some of the sub-tasks. Each virtual compute node may include one or more GPU cores allocated for performing a sub-task of the first set of sub-tasks or the second set of sub-tasks. In some embodiments, at least some of the first set of sub-tasks associated with the first LLM, such as LLM 122-1 and the second set of sub-tasks associated with the second LLM, such as LLM 122-2, may be executed in parallel across the number of virtual compute nodes.

FIG. 2 is a diagram 200 illustrating example hardware and software layers implemented on the single computing device of FIG. 1, in accordance with some embodiments of the technology described herein. As shown in FIG. 2, virtual compute nodes 112-1 and 112-2 may be created to process sub-task(s) associated with the first LLM and virtual compute nodes 132-1 and 132-2 may be created to process sub-task(s) associated with the second LLM. For each virtual compute node, the CPU, GPU, System RAM, GPU RAM, and other storage locations on the hard disk may be reserved and combined to create the virtual compute node. This virtual compute node may be generated and destroyed automatically during the execution process.

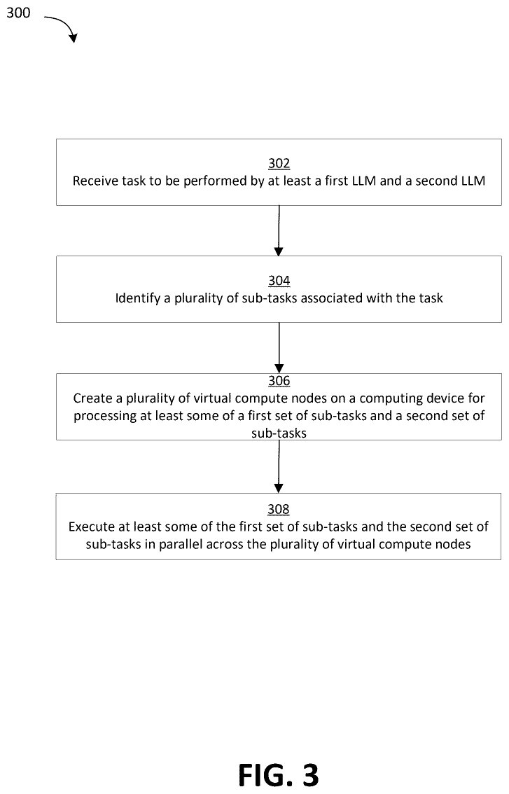

FIG. 3 is a flowchart of an illustrative process 300 for executing multiple large language models on a single physical computing device of FIG. 1, in accordance with some embodiments of the technology described herein. As shown in FIG. 3, process 300 comprises an act 302 of receiving a task to be performed by at least a first LLM and a second LLM; an act 304 of identifying a plurality of sub-tasks associated with the task; an act 306 of creating a plurality of virtual compute nodes on the single physical computing device for processing at least some of a first set of sub-tasks and a second set of sub-tasks, and an act 308 of executing at least some of the first set of sub-tasks and the second set of sub-tasks in parallel across the plurality of virtual compute nodes.

In act 302, a task to be performed by at least a first LLM and a second LLM may be received. In some embodiments, receiving a task may include receiving a natural language prompt identifying the task to be performed by at least the first LLM and the second LLM. For example, a prompt identifying a document summarization task may be received. In some embodiments, the prompt may be received by the External Service Listener 604 that passes the request to the IEMS 602. In some embodiments, the prompt may indicate a requested format for the document summary.

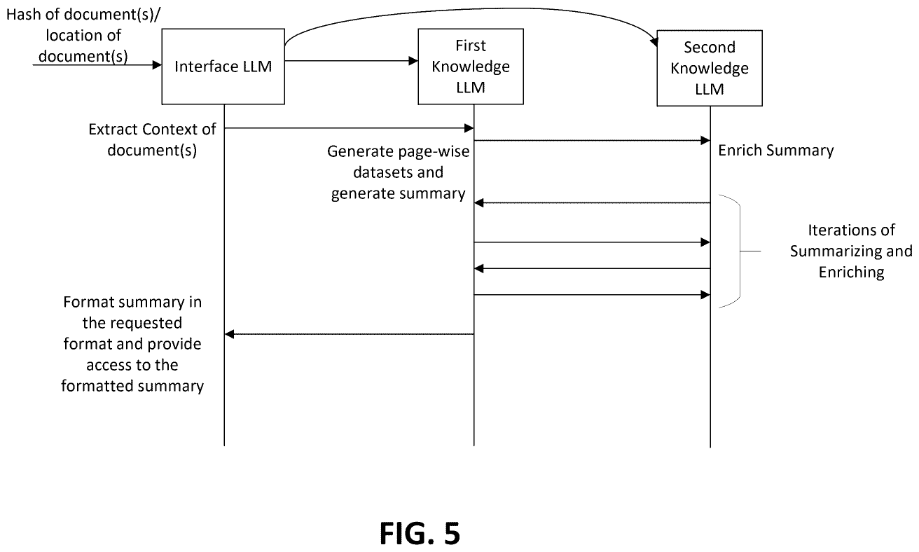

In act 304, a plurality of sub-tasks associated with the task may be identified. For example, sub-tasks associated with a document summarization task may include a first set of sub-tasks, such as generating a summary, to be performed by a first LLM (e.g., first knowledge LLM of FIG. 5), and a second set of sub-tasks, such as enriching the summary by checking for alternative words, to be performed by a second LLM (e.g., second knowledge LLM of FIG. 5). In some embodiments, as shown in FIG. 5, a hash of the document to be summarized and location of the document in the vector database may be provided as input to the Interface LLM. The Interface LLM may extract context of the document and provide the context to as input to the IEMS 602. In some embodiments, the IEMS 602 may identify the first knowledge LLM and the second knowledge LLM of FIG. 5 to process the summarization task for the document. The IEMS 602 may perform the identification based on the context.

At act 306, a plurality of virtual compute nodes, as shown in FIGS. 1 and 2, may be created on the single physical computing device for processing at least some of the first set of sub-tasks and the second set of sub-tasks. In some embodiments, each one of the plurality of virtual compute nodes includes one or more GPU cores allocated for performing a sub-task of the first set of sub-tasks or the second set of sub-tasks.

In some embodiments, a plurality of available GPU cores may be identified and one or more of the available GPU cores may be allocated for the first set of sub-tasks or second set of sub-tasks.

In some embodiments, each virtual compute node may include one or more memory resources allocated for performing the sub-task of the first set of sub-tasks or the second set of sub-tasks. A plurality of available memory resources may be identified and one or more of the plurality of available memory resources may be allocated for the first set of sub-tasks or the second set of sub-tasks.

In some embodiments, compute and memory resources needed to execute the first set of sub-tasks or the second set of sub-tasks may be determined. One or more of the plurality of available GPU cores and one or more of the plurality of available memory resources may be allocated on the single physical computing device based on the determined compute and memory resources. In some embodiments, the allocation of available GPU core(s) and available memory resources may be performed automatically by a processing layer (e.g., at least one a GPU kernel (e.g., GPU kernel 634 of FIG. 6) and a GPU driver (e.g., GPU driver 636 of FIG. 6)) transparent to the first and second LLMs.

At act 308, at least some of the first set of sub-tasks associated with the first LLM and the second set of sub-tasks associated with the second LLM may be executed substantially in parallel across the plurality of virtual compute nodes. In some embodiments, at least some of the first set of sub-tasks and the second set of sub-tasks may be executed using the allocated one or more of the plurality of available GPU cores and the one or more of the plurality of available memory resources.

In some embodiments, as shown in FIG. 5, the first knowledge LLM creates the page-wise dataset and generates a summary and the second knowledge LLM enriches the generated summary, thereby completing cycle 1. The first and second knowledge LLMs may process the entire dataset, page by page, by iterating through multiple cycles at least until the Interface LLM is satisfied by the summary. This summary may be formatted in a format requested in the prompt and access to the formatted summary may be provided via the Interface LLM.

In some embodiments, the process of executing multiple LLMs on the single physical computing device comprises providing access to data via a shared memory (as shown in FIG. 4, for example), wherein the data in the shared memory is accessible by the first LLM and the second LLM. In some embodiments, the shared memory may be used to share inferences between the multiple LLMs.

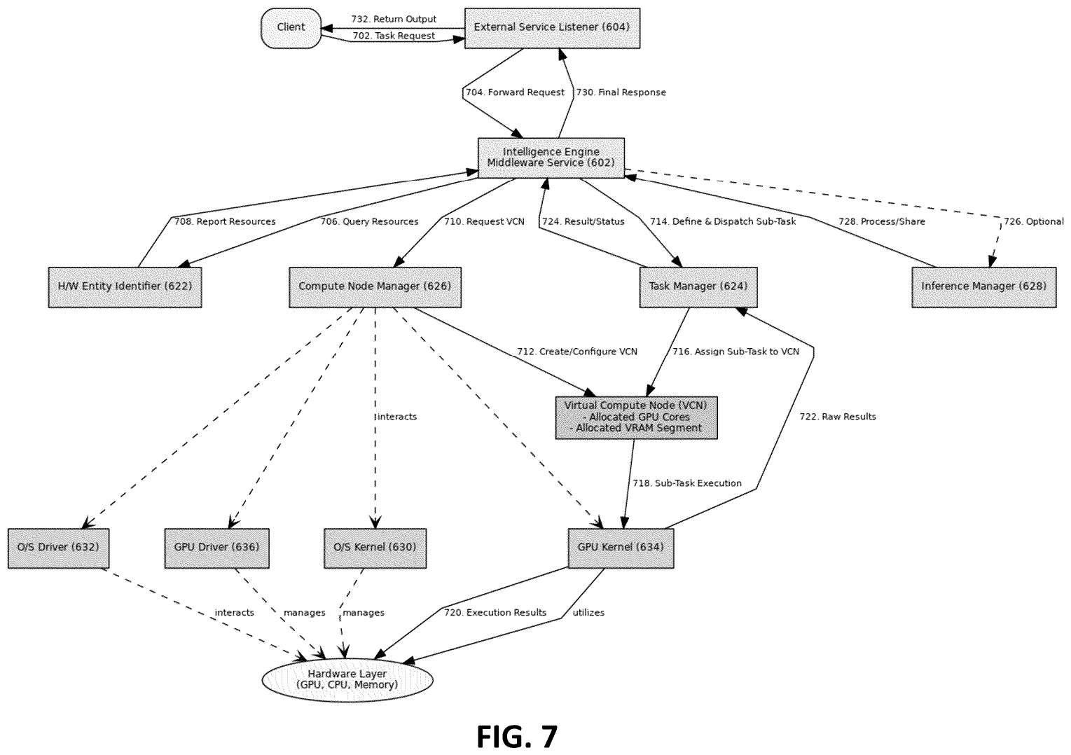

FIG. 7 is a diagram illustrating interactions between various components of the software component architecture (mSmartCompute software platform) of FIG. 6 to perform a requested inference task, in accordance with some embodiments of the technology described herein. The diagram of FIG. 7 illustrates how a task request from an external client is processed by the mSmartCompute platform of FIG. 6 to perform LLM inference sub-task(s). It shows the journey of the request through various components, the management of hardware resources, and the eventual return of a response.

As shown in FIG. 7, at step 702, a request to perform a task to be performed by a plurality of LLMs may be received by the External Service Listener 604 of the mSmartCompute software platform of FIG. 6. The request may be received from an external client and may include a natural language prompt identifying the task to be performed by the plurality of LLMs.

At step 704, the External Service Listener 604 receives the request and forwards it to the IEMS 602. At step 706, The IEMS 602 queries the H/W Entity Identifier 622 to determine the currently available hardware resources (GPU cores, memory, etc.). At step 708, The H/W Entity Identifier 622 reports the available system resources back to the IEMS 602.

At step 710, based on the task requirements and available resources, the IEMS 602 instructs the Compute Node Manager 626 to create or assign one or more Virtual Compute Nodes (VCNs). At step 712, the Compute Node Manager 626 creates and configures a VCN, allocating specific GPU cores and memory. This process may involve interaction(s) with the O/S Kernel 630, O/S Driver 632, GPU Kernel 634, and GPU Driver 636 to reserve and manage these hardware resources for the VCN. These interactions are shown as dashed lines between the Compute Node Manager 626 and the O/S Kernel 630, O/S Driver 632, GPU Kernel 634, and GPU Driver 636.

At step 714, the IEMS 602 defines a specific sub-task for an LLM and dispatches it to the Task Manager 624. At step 716, the Task Manager 624 assigns this sub-task to be executed on the designated VCN (where the target LLM's instance is conceptually running or will be loaded). At step 718, sub-task execution begins on the VCN. This involves the GPU Kernel 634 (e.g., representing the custom CUDA kernels for LLM operations) and the GPU Driver 636 orchestrating kernel launches on the GPU cores allocated to the VCN. These kernels utilize the VCN's dedicated VRAM segment within the Hardware Layer (representing the physical GPU(s), CPU, and Memory). The O/S Kernel 630 and O/S Driver 632 manage overall system resources and interactions with the Hardware Layer. As shown in FIG. 7, the solid line labeled “utilizes” between the GPU kernel 634 and the Hardware Layer shows utilization and the dashed lines labeled “interacts” or “manages” between the O/S Kernel 630, O/S Driver 632, O/S Kernel 630 and the Hardware Layer indicate their interaction and management roles.

At step 720, results from the GPU computation (e.g., logits, new tokens) are generated and stored within the VCN's VRAM on the Hardware Layer. At step 722, the GPU Kernel 634 (or routines managed by the GPU Driver 636) makes these raw results from the VCN available, which are then picked up by the Task Manager 624. At step 724, the Task Manager 624 reports the completion status and the result of the sub-task to the IEMS 602.

At step 726, the IEMS 602 may optionally pass the interim inference to the Inference Manager 628 for further processing or sharing (for example, if it needs to be shared with other LLMs as part of a larger workflow). At step 728, the Inference Manager 628 processes the inference. If it's an intermediate step, it manages sharing this inference (potentially with other LLMs via an internal mechanism, such as the internal service listener 606, orchestrated by IEMS 602). The inference manager 628 then reports back to or makes the processed/shared inference available to IEMS 602.

At step 730, the IEMS 602 formulates the final response for the original request (or this stage of it), potentially incorporating results from the Inference Manager 628. At step 732, The IEMS 602 sends the final response to the External Service Listener 604, which then returns the output or status to the external client.

It will be appreciated that while FIG. 7 depicts creation of a VCN for execution of a specific sub-task, the same flow/interactions are performed for a plurality of sub-tasks associated with the requested task, thereby resulting in creation of a plurality of VCNs for execution of the plurality of sub-tasks.

### Example Kernel and Driver Enhancements for Host OS Integration

The mSmartCompute software platform achieves its parallel LLM execution capabilities through modifications at the OS and hardware interaction level as stated below, for example, for GPGPUs on a Linux environment (Debian-based Ubuntu).
Direct Hardware Interaction: This involves creating customized kernels and drivers that allow LLMs to interact more directly with GPGPU compute nodes. This is a departure from traditional approaches where application-level limitations are not granularly handled at the hardware and firmware level.
Modified Kernel and Driver for GPGPU: The system modifies the kernel and driver of the GPGPU to enable direct access from the application layer (LLMs) to the hardware layer. This facilitates dynamic allocation of resources on the compute unit based on demand from each LLM. In one implementation, open-source Nvidia A/H 100 GPGPU code may be modified to allow Direct Memory Access (DMA) from the application layer, managed via C++ middleware. Python modules are then used to access C++ pointers for resource identification and management.
ModelDistributor and gRPC: While model_distributor.cpp primarily uses gRPC (Remote Procedure Call framework) for communication with a coordinator and workers, this communication infrastructure can be seen as part of the higher-level orchestration that leverages the underlying custom kernel and driver interactions for tasks like distributing models and checking worker health. The check_worker_health function, for instance, communicates with worker nodes, which would be running on OS instances with potentially customized driver interactions for resource reporting.
Synergy with AMD CPUs: The use of AMD CPUs with maximum virtual cores and DMA channels is emphasized to manage delegative tasks effectively, complementing the GPGPU customizations.

These modifications aim to bypass layers of abstraction that typically introduce latency and overhead, enabling faster data access and computation by keeping data within the system bus and minimizing network transmissions for LLM computations. A goal is to utilize dormant tensor cores more effectively than standard open-source drivers allow.

### Example Host System Memory Management and Reuse

The mSmartCompute software platform incorporates sophisticated mechanisms for managing host system memory, ensuring efficient utilization and reuse, which enables running multiple LLMs concurrently.
Resource Monitoring and Optimization (ResourceOptimizer):
   The ResourceOptimizer class (resource_optimizer.cpp) actively monitors system memory metrics, including total, free, and used memory, and calculates memory utilization.
   It implements strategies to optimize memory usage if utilization exceeds a configurable threshold (memory_threshold_).
   A feature for reuse is cleanup_unused_resources, which releases resources allocated to models that have been inactive for a defined period, making that memory available for other tasks.
LLM Instance Specific Resource Awareness (LLMInstance):
   The LLMInstance class (llm_instance.cpp) is designed with resource awareness. During initialization, it checks for sufficient resources, including a required_vram_mb configuration, against monitored resources. This implies that host memory availability is also a factor before an LLM instance is even loaded.
   It tracks resource_stats_ including memory_utilization, providing a per-instance view that can feed into the global ResourceOptimizer.
GPU Memory Manager (GPUMemoryManager) for Host-Side Operations:
   While focused on GPU memory, the GPUMemoryManager (as inferred from test_gpu_memory_manager.cpp) is instantiated and managed from the host. Its singleton nature (GPUMemoryManager::getInstance( )) ensures a centralized control point for memory operations that are initiated from the host CPU.
   The manager's initialize and reset functions are host-driven operations controlling the overall state of the GPU memory system. The memory statistics it provides (getMemoryStats) are accessible on the host for broader resource allocation decisions.

### Example Host to GPU Memory Sharing and DMA

Efficient data transfer between host (system memory) and GPU is important for optimizing task execution. The mSmartCompute software platform leverages and enhances this mechanism in following ways.
Customized DMA Access: As mentioned earlier, in one implementation, the open-source GPGPU code (e.g., for Nvidia A/H 100) is modified in C++ to allow DMA from the application layer. This enhancement enables direct and potentially more efficient data pathways than standard library calls might offer by default.
GPUMemoryManager:
   The GPUMemoryManager (inferred from test_gpu_memory_manager.cpp) enables managing GPU memory from the host.
   allocate (size_t size): Allocates memory on the GPU, returning a host-accessible pointer (or an opaque handle that maps to GPU memory).
   free (void* ptr): Frees previously allocated GPU memory from the host.
   reallocate (void* ptr, size_t new_size): Reallocates GPU memory, potentially involving data transfers orchestrated from the host.
   Memory Pools (createMemoryPool, allocateFromPool, freeToPool): This feature allows for pre-allocation of larger GPU memory chunks and sub-allocation from these pools. This can significantly reduce the overhead of frequent cudaMalloc/cudaFree calls and improve memory reuse, managed from the host side.
   Memory Alignment: The manager ensures memory alignment (e.g., 256-byte alignment), which is an important aspect for performance and compatibility with certain GPU operations and tensor core usage.
Asynchronous Data Movement: Asynchronous barriers in memory sharing and CUDA streams are leveraged. The Nvidia H100's capability for global-to-shared asynchronous transfers across all address spaces is a feature that enables applications to build end-to-end asynchronous pipelines, hiding data movement with computation. mSmartCompute's custom drivers and kernels are designed to fully exploit this.
Model Loading in LLMInstance:
   LLMInstance: loadWeights reads model weights from a file path. These weights, once read into host memory, are then transferred to the GPU for the TransformerBlock and final_layer_norm_ initialization. The efficiency of this transfer benefits from the custom DMA and memory management capabilities.
   Similarly, LLMInstance in llm_instance.cpp uses a GGUFLoader to load models, which involves reading data from files into host memory and subsequently making it available to the InferenceEngine that operates on the GPU.

The ability to customize address spaces and locations within a single GPU device and manage these via C++ middleware allows for enhanced host-to-GPU memory interaction in mSmartCompute software.

### Example Resource Optimization

mSmartCompute employs a multi-faceted approach to resource optimization, ensuring that CPU, GPU, and memory are used efficiently, particularly when running multiple LLMs.
ResourceOptimizer Class (resource_optimizer.cpp): This class is dedicated to active resource optimization.
   Memory and GPU Monitoring: Continuously monitors system memory and GPU metrics (utilization, free/used memory).
   Threshold-Based Optimization: Triggers optimization routines (optimize_memory_usage, optimize_gpu_usage) when utilization exceeds predefined thresholds. For instance, if GPU memory is highly utilized and fragmented, it can reset the GPU device to clear memory.
   Dynamic Resource Allocation and Release:
      allocate_resources (model_id, allocation): Allocates specified CPU cores, memory, and GPU memory to a model if resources are available.
      release_resources (model_id): Frees resources associated with a model.
      cleanup_unused_resources( ): Automatically reclaims resources from models inactive for a certain duration, promoting efficient reuse.
   Resource Scaling and Redistribution:
      scale_resources (model_id, scale_factor): Adjusts the resources allocated to a model based on a scaling factor.
      redistribute_resources( ): Initiates a broader optimization of resource distribution across active models.
   Performance History: Maintains performance metrics (inference_latency, throughput, etc.) per model, which can inform future optimization decisions.
ModelOptimizer Class (model_optimizer.cpp): This class focuses on optimizing the LLMs themselves for better performance and reduced resource footprint.
   Quantization: Implements 4-bit (simulated) and 8-bit quantization to reduce model size and potentially speed up inference.
   Pruning: Applies structured and unstructured pruning to remove less important model weights, leading to smaller and faster models.
   Distillation: Prepares for and applies knowledge distillation to train smaller student models that mimic larger teacher models.
   Other optimization techniques may be used including QLoRA (Quantized Low-Rank Adaptation), flash attention, CPU offloading, gradient checkpointing, tensor parallelism, Just-in-time (JIT) compilation, and (Open Neural Network Exchange) ONNX export, all contributing to resource efficiency.
ModelDistributor (model_distributor.cpp):
   Before distributing a model, it checks worker health and resource availability (e.g., active models against a threshold). This prevents overloading workers and ensures models are placed on capable nodes.
   get_optimal_worker (model_id): Selects a worker based on the lowest load, promoting balanced resource utilization across the distributed system.
   Worker resource information is cached and updated (get_worker_resources, allocate_worker_resources), contributing to informed distribution decisions.
ConcurrencyController (concurrency_controller.cpp):
   Manages the number of concurrent requests (maxConcurrentRequests_) and batch sizes (maxBatchSize_) to control the load on LLM instances, preventing resource exhaustion and optimizing throughput.
LLMInstance (llm_instance.cpp):
   The instance itself monitors its resource usage (updateResourceUsage) and reports it, contributing to the overall resource management picture.
   It processes requests from a queue in a worker thread, allowing controlled execution and resource consumption.

The concepts of dynamic resource allocation (DMA) based on demand from LLMs and creation of virtual compute nodes (that get freed up when tasks are finished) are supported by the functionalities within ResourceOptimizer and ModelDistributor.

Example GPU Kernel (CUDA Kernel) Modifications in mSmartCompute

mSmartCompute significantly enhances CUDA kernel implementations to accelerate LLM operations, moving beyond standard library functionalities by providing specialized and optimized kernels managed within a structured framework. This aligns with the objective of customizing computation at the tensor core level for parallel task execution. Following is a list of some modifications done to the GPU kernel code.
CUDA Kernels:
   Core Network Operations: Custom kernels that allow for fine-tuned execution of fundamental neural network passes.
   Activation Functions: Custom kernels that provide optimized implementations for common activations.
   Optimization: Custom kernels that provide a specific optimization algorithm directly on the GPU.
   Normalization & Regularization: Custom kernels provided for normalization and regularization of neural network techniques used for managing GPU workload.
   Attention Mechanism: A customized implementation of the attention algorithm, commonly used in neural networks like transformers, optimized for parallel execution on a GPU. Attention allows a model to focus on relevant parts of the input by assigning weights to elements (e.g., words in a sentence) based on their importance to the current context.
   Metrics Computation: Custom kernels for computing accuracy and precision mechanism to offload metric calculations to the GPU.
   Resource Management: The CUDAManager singleton manages CUDA resources to speed up matrix and vector computations and run the streams efficiently, along with error handling via CUDA_CHECK.
Transformer-Specific Kernels:
   Optimized Building Blocks: Provides kernels specifically for Transformer architectures:
      layerNormKernel: A custom implementation for layer normalization.
      attentionKernel: A core attention mechanism, including score computation, scaling, softmax, and value aggregation. This allows for variations or optimizations not present in standard libraries.
      ffnKernel: It implements the position-wise Feed-Forward Network.
   Kernel Configuration & Launch: Defines constants (BLOCK_SIZE, WARP_SIZE) and helpers (getGridDim) for optimal kernel launch configurations. Host wrapper functions (e.g., launchLayerNorm, launchAttention, launchFFN) simplify kernel execution with specified parameters and CUDA streams.
   Advanced Parallelism: These kernels utilize cooperative groups for efficient parallel reduction and synchronization, indicating a deep level of optimization.
Specialized CUDA Kernels Framework: This framework represents a significant enhancement for managing diverse, high-performance CUDA operations.
   Configuration (SpecializedKernelConfig): A unified structure to pass parameters like tensor core usage, precision, block/grid dimensions, and stream, tailored for different kernel types. This allows for dynamic and optimized kernel launches.
   Extensible Kernel Architecture:
      CUDASpecializedKernel (Base Class): This custom specialized Kernel defines a common interface (initialize, shutdown, execute) for all specialized kernels.
      Derived Kernel Classes: Provide tailored implementations for various domains as stated below:
         CUDATransformerKernel: Manages self-attention, multi-head attention, feed-forward layers, layer normalization, and dropout, often using cuBLAS (CUDA Basic Linear Algebra Subroutines) for matrix multiplications and cuDNN (CUDA Deep Neural Network) for operations like softmax (cudnnSoftmaxForward) and activations (cudnnActivationForward).
         CUDACNNKernel: For convolution (cudnnConvolutionForward), pooling (cudnnPoolingForward), batch normalization, and activations in CNNs.
         CUDARNNKernel: For GRU (Gated Recurrent Unit), a type of recurrent neural network (RNN) architecture and the standard RNN layers.
         CUDAImageProcessingKernel & CUDA VideoProcessingKernel: Extend GPU acceleration to image/video tasks like rotation/spatial transformation, filtering, and normalization, potentially for multi-modal LLMs.
         CUDATrainingKernel: Supports model training with custom backwardPass, updateWeights, and computeLoss kernels.
         CUDAPreTrainedModelKernel: Manages loading, saving, inference, and fine-tuning of pre-trained models.
   Centralized Kernel Management (CUDASpecializedKernelManager): A singleton manager to create, destroy, and execute these specialized kernels by type. It acts as a factory (createKernel) and execution orchestrator (executeKernel). This manager ensures that the appropriate, optimized kernel is used for each specific task.
CUDA Kernel Testing:
   A dedicated testing environment using Google Test (CUDATestFixture) ensures the correctness and performance of these custom kernels, crucial for reliability.

These custom GPU kernels (CUDA kernels) and the framework for managing them allow mSmartCompute to achieve a higher degree of parallelism and efficiency than relying solely on off-the-shelf libraries. They enable direct control over GPU execution, memory access patterns, and synchronization, which is important for the “multiple LLM execution capability” on customized hardware setups. The use of cuBLAS and cuDNN within these custom wrappers indicates leveraging highly optimized NVIDIA libraries where appropriate, but orchestrating them within a more flexible and specialized framework.

The mSmartCompute platform also includes code that dynamically updates the Operating System drivers during the installation process, based on the specific hardware components of the machine. This allows mSmartCompute to run optimally on that hardware.

### Additional Implementation Detail

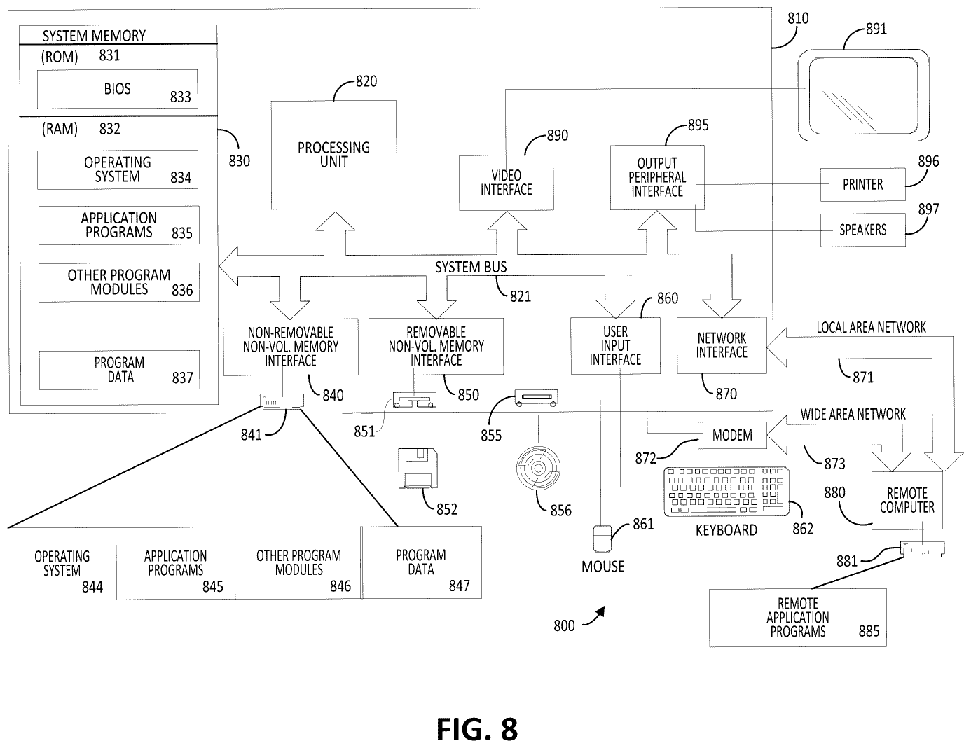

FIG. 8 illustrates an example of a suitable computing system environment 800 on which the technology described herein may be implemented. The computing system environment 800 is only one example of a suitable computing environment and is not intended to suggest any limitation as to the scope of use or functionality of the technology described herein. Neither should the computing environment 800 be interpreted as having any dependency or requirement relating to any one or combination of components illustrated in the exemplary operating environment 800.

The technology described herein is operational with numerous other general purpose or special purpose computing system environments or configurations. Examples of well-known computing systems, environments, and/or configurations that may be suitable for use with the technology described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The computing environment may execute computer-executable instructions, such as program modules. Generally, program modules include routines, programs, objects, components, data structures, etc. that perform particular tasks or implement particular abstract data types.

With reference to FIG. 8, an exemplary system for implementing the technology described herein includes a general purpose computing device in the form of a computer 810. Components of computer 810 may include, but are not limited to, a processing unit 820 (e.g., a graphics processing unit (GPU), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 810. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computer 810 may also include other removable/non-removable, volatile/nonvolatile computer storage media. By way of example only, FIG. 8 illustrates a hard disk drive 841 that reads from or writes to non-removable, nonvolatile magnetic media, a flash drive 851 that reads from or writes to a removable, nonvolatile memory 852 such as flash memory, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media described above and illustrated in FIG. 8, provide storage of computer readable instructions, data structures, program modules and other data for the computer 810. In FIG. 8, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies. An actor may enter commands and information into the computer 810 through input devices such as a keyboard 862 and pointing device 861, commonly referred to as a mouse, trackball or touch pad. Other input devices (not shown) may include a microphone, joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A monitor 891 or other type of display device is also connected to the system bus 821 via an interface, such as a video interface 890. In addition to the monitor, computers may also include other peripheral output devices such as speakers 897 and printer 896, which may be connected through an output peripheral interface 795.

The computer 810 may operate in a networked environment using logical connections to one or more remote computers, such as a remote computer 880. The remote computer 880 may be a personal computer, a server, a router, a network PC, a peer device or other common network node, and typically includes many or all of the elements described above relative to the computer 810, although only a memory storage device 881 has been illustrated in FIG. 8. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 871 or other means for establishing communications over the WAN 873, such as the Internet. The modem 872, which may be internal or external, may be connected to the system bus 821 via the actor input interface 860, or other appropriate mechanism. In a networked environment, program modules depicted relative to the computer 810, or portions thereof, may be stored in the remote memory storage device. By way of example, and not limitation, FIG. 8 illustrates remote application programs 885 as residing on memory device 881. It will be appreciated that the network connections shown are exemplary and other means of establishing a communications link between the computers may be used.

Having thus described several aspects of at least one embodiment of the technology described herein, it is to be appreciated that various alterations, modifications, and improvements will readily occur to those skilled in the art. Such alterations, modifications, and improvements are intended to be part of this disclosure, and are intended to be within the spirit and scope of disclosure. Further, though advantages of the technology described herein are indicated, it should be appreciated that not every embodiment of the technology described herein will include every described advantage. Some embodiments may not implement any features described as advantageous herein and in some instances one or more of the described features may be implemented to achieve further embodiments. Accordingly, the foregoing description and drawings are by way of example only.

The above-described embodiments of the technology described herein can be implemented in any of numerous ways. For example, the embodiments may be implemented using hardware, software or a combination thereof. When implemented in software, the software code can be executed on any suitable processor or collection of processors, provided in a single computer. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. However, a processor may be implemented using circuitry in any suitable format.

Further, it should be appreciated that a computer may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable or fixed electronic device.

Also, a computer may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, aspects of the technology described herein may be embodied as a computer readable storage medium (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments described above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computers or other processors to implement various aspects of the technology as described above. As used herein, the term “computer-readable storage medium” encompasses only a non-transitory computer-readable medium that can be considered to be a manufacture (i.e., article of manufacture) or a machine. Alternatively or additionally, aspects of the technology described herein may be embodied as a computer readable medium other than a computer-readable storage medium, such as a propagating signal.

The terms “program” or “software” are used herein in a generic sense to refer to any type of computer code or set of computer-executable instructions that can be employed to program a computer or other processor to implement various aspects of the technology as described above. Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various aspects of the technology described herein may be used alone, in combination, or in a variety of arrangements not specifically described in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the technology described herein may be embodied as a method, of which examples are provided herein including with reference to FIG. 3. The acts performed as part of any of the methods may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by an “actor” or a “user”. It should be appreciated that an “actor” or a “user” need not be a single individual, and that in some embodiments, actions attributable to an “actor” or a “user” may be performed by a team of individuals and/or an individual in combination with computer-assisted tools or other mechanisms.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1. A method for executing multiple large language models (LLMs) on a single physical computing device, the method comprising:
receiving a task to be performed by at least a first LLM and a second LLM;
identifying a plurality of sub-tasks associated with the task, the plurality of sub-tasks including a first set of sub-tasks to be performed by the first LLM and a second set of sub-tasks to be performed by the second LLM;
creating a plurality of virtual compute nodes on the single physical computing device for processing at least some of the first set of sub-tasks and the second set of sub-tasks, wherein each one of the plurality of virtual compute nodes includes one or more graphics processing unit (GPU) cores allocated for performing a sub-task of the first set of sub-tasks or the second set of sub-tasks; and
executing at least some of the first set of sub-tasks associated with the first LLM and the second set of sub-tasks associated with the second LLM substantially in parallel across the plurality of virtual compute nodes.

2. The method of claim 1, wherein receiving the task comprises:
receiving a natural language prompt identifying the task to be performed by at least the first LLM and the second LLM.

3. The method of claim 1, further comprising:
identifying a plurality of available GPU cores; and
allocating one or more of the plurality of available GPU cores for the first set of sub-tasks or the second set of sub-tasks.

4. The method of claim 3, wherein each virtual compute node includes one or more memory resources allocated for performing the sub-task of the first set of sub-tasks or the second set of sub-tasks, and the method further comprises:
identifying a plurality of available memory resources; and
allocating one or more of the plurality of available memory resources for the first set of sub-tasks or the second set of sub-tasks.

5. The method of claim 4, further comprising:
determining compute and memory resources needed to execute the first set of sub-tasks or the second set of sub-tasks; and
allocating the one or more of the plurality of available GPU cores and the one or more of the plurality of available memory resources on the single physical computing device based on the determined compute and memory resources.

6. The method of claim 5, wherein executing at least some of the first set of sub-tasks and the second set of sub-tasks in parallel across the plurality of virtual compute nodes comprises:
executing at least some of the first set of sub-tasks and the second set of sub-tasks using the allocated one or more of the plurality of available GPU cores and the one or more of the plurality of available memory resources.

7. The method of claim 1, wherein the first set of sub-tasks performed by the first LLM are different from the second set of sub-tasks performed by the second LLM.

8. The method of claim 1, further comprising:
providing access to data via a shared memory, wherein the data in the shared memory is accessible by the first LLM and the second LLM.

9. The method of claim 1, wherein the one or more graphics processing unit (GPU) cores are located within a same GPU device that comprise the one or more GPU cores.

10. The method of claim 5, wherein the act of allocating the one or more of the plurality of available GPU cores and the one or more of the plurality of available memory resources on the single physical computing device based on the determined compute and memory resources is performed automatically by a processing layer transparent to the first LLM and the second LLM.

11. The method of claim 10, wherein the processing layer includes at least one of a GPU kernel and a GPU driver.

12. The method of claim 1, further comprising:
dynamically sharing inferences related to natural language prompts between the first LLM and the second LLM.

13. A computing device configured to execute multiple large language models (LLMs), the computing device comprising:
at least one processor; and
at least one non-transitory computer-readable storage medium storing instructions that, when executed by the at least one processor, cause the at least one processor to perform a method comprising:
receiving a task to be performed by at least a first LLM and a second LLM;
identifying a plurality of sub-tasks associated with the task, the plurality of sub-tasks including a first set of sub-tasks to be performed by the first LLM and a second set of sub-tasks to be performed by the second LLM;
creating a plurality of virtual compute nodes on the computing device for processing at least some of the first set of sub-tasks and the second set of sub-tasks, wherein each one of the plurality of virtual compute nodes includes one or more graphics processing unit (GPU) cores allocated for performing a sub-task of the first set of sub-tasks or the second set of sub-tasks; and
executing at least some of the first set of sub-tasks associated with the first LLM and the second set of sub-tasks associated with the second LLM in parallel across the plurality of virtual compute nodes.

14. The computing device of claim 13, wherein receiving the task comprises:
receiving a natural language prompt identifying the task to be performed by at least the first LLM and the second LLM.

15. The computing device of claim 13, wherein the method further comprises:
identifying a plurality of available GPU cores; and
allocating one or more of the plurality of available GPU cores for the first set of sub-tasks or the second set of sub-tasks.

16. The computing device of claim 15, wherein each virtual compute node includes one or more memory resources allocated for performing the sub-task of the first set of sub-tasks or the second set of sub-tasks, and the method further comprises:
identifying a plurality of available memory resources; and
allocating one or more of the plurality of available memory resources for the first set of sub-tasks or the second set of sub-tasks.

17. The computing device of claim 16, wherein the method further comprises:
determining compute and memory resources needed to execute the first set of sub-tasks or the second set of sub-tasks; and
allocating the one or more of the plurality of available GPU cores and the one or more of the plurality of available memory resources on the computing device based on the determined compute and memory resources.

18. The computing device of claim 17, wherein executing at least some of the first set of sub-tasks and the second set of sub-tasks in parallel across the plurality of virtual compute nodes comprises:
executing at least some of the first set of sub-tasks and the second set of sub-tasks using the allocated one or more of the plurality of available GPU cores and the one or more of the plurality of available memory resources.

19. The computing device of claim 17, wherein the act of allocating the one or more of the plurality of available GPU cores and the one or more of the plurality of available memory resources on the computing device based on the determined compute and memory resources is performed automatically by a processing layer transparent to the first LLM and the second LLM.

20. At least one non-transitory computer-readable storage medium storing instructions that, when executed by at least one processor, cause the at least one processor to perform a method comprising:
receiving a task to be performed by at least a first LLM and a second LLM;
identifying a plurality of sub-tasks associated with the task, the plurality of sub-tasks including a first set of sub-tasks to be performed by the first LLM and a second set of sub-tasks to be performed by the second LLM;
creating a plurality of virtual compute nodes on a single physical computing device for processing at least some of the first set of sub-tasks and the second set of sub-tasks, wherein each one of the plurality of virtual compute nodes includes one or more graphics processing unit (GPU) cores allocated for performing a sub-task of the first set of sub-tasks or the second set of sub-tasks; and
executing at least some of the first set of sub-tasks associated with the first LLM and the second set of sub-tasks associated with the second LLM in parallel across the plurality of virtual compute nodes.
